(19) United States
(12) Patent Application Publication
(10) Pub. No.: US 2025/0015517 A1
(43) Pub. Date: Jan. 9, 2025

(54) METHOD FOR CONNECTING AN ELECTRICAL CONDUCTOR MADE OF ALUMINIUM TO A TUBE MADE OF COPPER

(71) Applicant: Strunk Connect automated solutions GmbH & Co. KG, Kirchen (DE)

(72) Inventors: Olaf STRUNK, Kirchen-Freusburg (DE); Jakob SCHILLINGER, Gaimersheim (DE); Uwe KEIL, Hückeswagen (DE)

(73) Assignee: Strunk Connect automated solutions GmbH & Co. KG, Kirchen (DE)

(21) Appl. No.: 18/710,000

(22) PCT Filed: Nov. 9, 2022
(86) PCT No.: PCT/EP2022/081208

§ 371 Date: May 14, 2024

(30) Foreign Application Priority Data
Nov. 15, 2021 (DE) 10 2021 129 706.0

(51) Int. Cl. H01R 4/18; H01R 4/62; H01R 43/048

(52) U.S. Cl. CPC H01R 4/187; H01R 4/625; H01R 43/048

(57) ABSTRACT

A method for connecting an aluminum electrical conductor to a copper terminal is to be improved such that electrical connections between the conductor and the terminal can be established quickly and cost-effectively, these connections being durably stable and fluctuations in quality of these connections being prevented as far as possible. For this purpose the conductor is hard-soldered to the terminal in a first step, and a diffusion bond and/or fused bond with the hard solder layer is brought about in a second step by softening the aluminum strand bundle.

### CROSS-REFERENCE TO RELATED APPLICATION

This application is a national stage application, filed under 35 U.S.C. § 371, of International Patent Application PCT/EP2022/081208, filed on Nov. 9, 2022, which claims the benefit of German Patent Application DE 10 2021 129 706.0, filed on Nov. 15, 2021.

### TECHNICAL FIELD

The disclosure relates to a method for connecting an electrical conductor, which is formed as an aluminum or aluminum alloy strand, to copper or copper alloy electrical terminal which has, in addition to the terminal element, a tube for accommodating the end of the electrical conductor. The tubes can be open on one or both sides.

### BACKGROUND

The use of copper or copper alloys as conductors for electric current has long been known. In motor vehicles, in particular in electric vehicles, it is desirable to replace these copper or copper alloy electrical conductors with aluminum or aluminum alloy conductors for weight reasons. The use of aluminum conductors which are first crimped with and then welded to terminal elements made of other materials is already known from EP2362 491 A1 or EP2 621 022 A1.

Such connections cause major problems with regard to the duration of the mechanical stability of the connection as well as its electrical conductivity, e.g., when using aluminum conductors and copper terminal elements. If moisture is able to enter such a connection, contact corrosion occurs, which increases the transition resistance and significantly reduces the mechanical durability of the connection.

However, the main problems in connecting aluminum electrical conductors with terminal elements of a dissimilar material are that aluminum has a strong affinity for oxygen and as a result becomes covered with a dense, electrically insulating, very hard and very resistant oxide layer in a very short time. The melting point of this oxide layer, also known as corundum, is approx. 2,050° C., i.e., considerably higher than the melting point of aluminum, which is approx. 660° C., or copper, which is approx. 1,080° C.

Due to the usually round shape of the aluminum wires of the strand, with or without non-conductive coating, cavities form between the wires. Moisture can penetrate into these cavities and lead to localized corrosion of the aluminum wire. This leads to a mechanical weakening and an increase in conductor resistance. However, the cavities are also present in shaped wire with or without coating.

In addition, the melting of the two aluminum and copper materials to be connected can result in the formation of intermetallic phases, which are both brittle and have a higher resistance, so that high heat generation can occur in this region during subsequent current flow. This increased temperature causes the intermetallic layer to be further augmented over time. Due to the brittleness of the connection, the connection can break easily even under low mechanical stresses. EP 2 621 022 A1 attempts to avoid the formation of intermetallic phases by using complex CUPAL sleeves.

Another problem is that the melting temperatures of the two connection partners differ widely from one another. This poses the risk that the aluminum will already start to fuse while the dissimilar material, such as copper, has not yet reached its melting temperature, which results in inadequate welds that do not achieve the required strength. Such inadequate welds are usually not visible from the outside, so there is a risk that electrical conductors will be used which are insufficiently connected to the terminal element in this way.

The time lag known from the prior art between the crimping in a first stage, in which the oxide layer is broken up, and a second stage at a separate location, in which the elements are welded together, can also lead to renewed oxidation, which can result in strong, untraceable fluctuations in the connection quality. The quality of the connection is also heavily dependent on the quality of the aluminum strands.

### SUMMARY

The object of the disclosure is to establish electrical connections between aluminum or aluminum alloy electrical conductors and a copper or copper alloy electrical terminal quickly and cost-effectively, these connections being durably stable and fluctuations in quality of these connections being prevented as far as possible, while avoiding the disadvantages described.

The following method steps are proposed to achieve the object:
a) Coating the inner surfaces of the tube with a hard solder or using a tube coated on the inner surface with a hard solder,
b) After inserting the end of the electrical conductor into the tube, plastic deformation of the tube in the region of the end of the tube on the terminal element side, wherein the individual wires of the strand are deformed by overstamping in such a way that their non-conductive oxide layers are broken up and the individual wires are pressed together in a gap-free manner,
c) Applying a predeterminable pressing force and a predeterminable current for a predeterminable time via electrodes, depending on the geometry and material properties of the tube and the strand, for generating Joule heating of the aluminum strand bundle, wherein the Joule heating melts the hard solder and creates a hard solder connection between the inner surfaces of the tube and the outer regions of the aluminum strand bundle in contact therewith,
d) Applying a further predeterminable pressing force and a further predeterminable current for a further predeterminable time, also depending on the geometry and the material properties of the tube and the strand, softening the aluminum strand bundle such that a diffusion of the aluminum strand bundle and/or an at least partial melting of the aluminum strand bundle occurs.

In this context, hard solder is understood to be a metal that has a eutectic melting temperature with the aluminum or aluminum alloy below the melting temperature of the aluminum or aluminum alloy. Preferably, a hard solder is selected that acts as a diffusion barrier to prevent the formation of intermetallic phases between aluminum and copper. For less high-quality, durable, and stable connections, a coating with soft solder could also be used. By overstamping the tube during plastic deformation, not only are the oxide layers on the individual wires of the strand broken up, but the wires are pressed so tightly together that no gap remains between the individual wires into which oxygen or gas could penetrate or remain, so that re-oxidation can no longer take place in this overstamped region. The stranded wires lying closer together and the associated increase in the contact surface of the stranded wires with one another other reduces the overall transition resistance of the wires. The subsequent two-stage connection, i.e., bonding the outer aluminum wires or their alloys to the coating by hard soldering, prevents new oxide layers from forming on the surface of the strand and, above all, minimizes the transition resistance between the copper tube and the outer surface of the strand. The subsequent diffusion process and/or partial melting process for the core of the strand minimizes the transition resistance between the individual wires of the strand. Other tools can be used for the deformation process, e.g., having active surfaces with sizes different from the active surfaces of the electrodes for the hard soldering process. At least one set of different process parameters is usually required for each of these two stages. The stages can also be subdivided into a plurality of intervals or steps with different pressure or force/current/time specifications. This means that the energy supply can be finely metered, e.g., to prevent massive melting of the conductor.

However, it is also worth imitating if the method features b) and c) are carried out simultaneously or immediately one after the other.

Although in this case the electrodes are used both for producing the plastic deformation and for carrying out the hard soldering process, this allows for shorter times between the deformation process and the hard soldering process, so that the re-oxidation of the strand surface can be prevented as far as possible.

When the plastic deformation by the electrodes occurs in immediate succession or simultaneously, the electrodes also induce the reshaping of the tube and the compaction of the stranded wires. The required forces can be significantly reduced by a constant or modulated preheating current which flows via the electrodes. The compacting phase, the hard soldering phase, the diffusion or melting phase, and the cooling phase can be determined by various pressing forces and/or energy inputs. However, the compacting phase can also be partially integrated into the hard soldering phase and/or diffusion phase. The latter describes a process in which a further continuous compaction takes place during the soldering and/or diffusion phase. The force application time during the ramped heating to the hard soldering temperature, but also soft soldering temperature, can also be used for compacting. Due to the locally different temperature distribution within the composite of tube and strand, the hard soldering and diffusion or melting processes can overlap in time.

The diffusion process is also controlled by pressing force, temperature, and time. The temperature in the connection zone must lie between the lowest melting temperature and the highest recrystallization temperature of the connection partners.

A plastic deformation of the region of the end of the tube on the conductor side such that the tube fits against the electrical conductor in the form of a sealing sleeve has proven useful.

This results in the strand being held even more securely in the tube for the subsequent or simultaneous hard soldering process. The transition region of the strand between the plastic deformation on the terminal side and on the conductor side should be subjected to as little stress as possible in order to avoid damage to the stranded wires due to overexpansion. In addition, the transition resistance of the sealing sleeve on the conductor side must be significantly higher than that of the plastic deformation on the terminal side in order to avoid a shunt for the current required for hard soldering, diffusion or melting.

If the individual wires of the strand are not only to be firmly connected with one another by diffusion, but the strand core is to be partially or completely melted, it is expedient if a melt reserve is formed between the deformation on the terminal element side and the deformation on the conductor end side.

This ensures that melt can enter the melt reserve if necessary, but cannot escape to the outside. The size of the melt reserve can be determined prior to the deformation process since melt can certainly also enter between the non-compacted regions of the strand and does not have to escape from there to the outside.

In this case, plastic deformation can also be carried out prior to or simultaneously with the hard soldering process.

The pressing tools or electrodes can advantageously be heated during the deformation process and/or during the hard soldering process and/or the diffusion or melting process, or consist of a material which heats up when current flows through it.

In principle, the heat required for hard soldering, diffusion, or melting is to be generated as a result of Joule self-heating by means of current flowing through the elements to be connected. During the deformation process used for compaction, heated tools or electrodes can make the materials to be connected more pliable, so that less force has to be applied for overstamping. The reduction in pressing force leads to gentler reshaping, expansion, and compression of the tube and the stranded wires and to a lower pressure load on the electrodes. In the case of hard soldering, if the electrodes are heated, less of the heat required for hard soldering is lost via the electrodes. If the electrodes are made of tungsten materials, for example, these would heat up when current flows through them, resulting in an additional heat source for the soldering process and/or the diffusion process and/or the melting process.

It is worth imitating if the tools or electrodes of the pressing tool and/or the electrode pairs are moved simultaneously.

This reduces the expansion of the upper or lower outer wires of the strand next to the compacting region of the strand.

It is advantageous if electrodes with active surfaces smaller than the active surfaces of the deformation tools in the compaction step are used for hard soldering, and non-conductive, lateral boundaries of the tube provide an essentially rectangular or square shape in the deformation and energization region.

Due to the different size of the pressing surface of the deformation tools relative to the electrodes, lateral termination zones are created on the tube, which serve to prevent lateral contact between the electrodes and the plastically deformed tube. The tube can be softened by heating during the deforming compaction and hard soldering. However, the boundaries adjoining the entire surface at the top, bottom and sides prevent a widening, as would be the case with a hexagonal contour, for example. The all-round clamping prevents the compacted connection from loosening. The additional lateral clamping thus prevents the tube or the compacted strand from expanding. The coating of the lateral boundary components is preferably neither electrically nor thermally conductive. If possible, neither heat dissipation nor an electrical shunt should occur here. Ceramic is preferably used, in ceramic-coated steel or directly. The tube contour comes about during the plastic deformation. In the subsequent hard soldering, diffusion, or melting, the lateral boundary prevents the pressed connection from loosening.

### BRIEF DESCRIPTION OF THE DRAWINGS

The invention is explained in more detail with the aid of illustrative drawings. Shown are:

FIG. 1 an example with predeformation for hard soldering and subsequent diffusion of the strand,

FIG. 2 another example with predeformation, a sealing sleeve and a melt reserve,

FIG. 3 a third example with predeformation, a sealing sleeve and a small melt reserve,

FIG. 4 an example with plastic deformation carried out by electrodes,

FIG. 5 an example as shown in FIG. 4 with an additional sealing sleeve, and

FIG. 6 an example of the structure of the electrodes.

### DETAILED DESCRIPTION

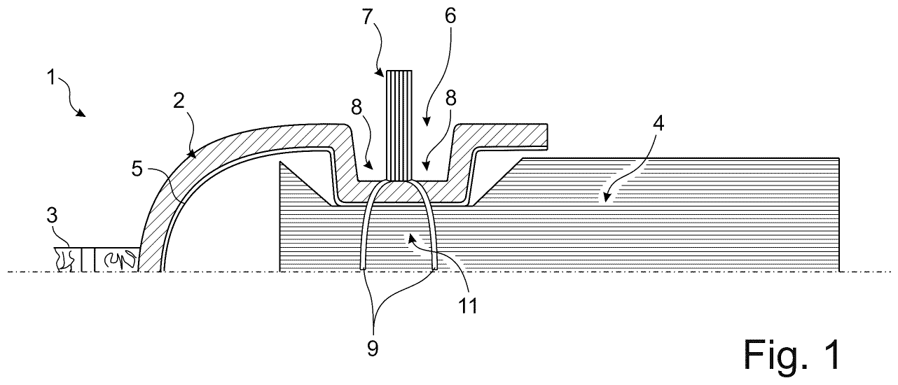

FIG. 1 shows, in sectional view, an electrical terminal 1, consisting of a tube 2 made of copper and a terminal element 3, wherein the end of a strand 4 made of aluminum is inserted into the tube 2. The tube 2 is coated on the inside with a hard solder 5.

The tube 2 has already been subjected to a plastic deformation 6 on the terminal side. Here, the active surface of the deformation tool, which tool is not shown, was larger than the surface of the electrode 7, wherein termination zones 8 are formed in the tube 2 next to the centrally fitted electrode 7, which zones ensure that the hard solder current and/or diffusion current or melting current, indicated by the current flow lines 9, flows predominantly via the strand 4.

Below the plastic deformation 6 on the terminal side, it is indicated that the strand 4 is highly compacted, wherein on the one hand the oxide layers of the individual wires of the strand 4 have been broken up and the individual wires of the strand 4 are pressed together in a gap-free manner. When the electrodes are energized, Joule self-heating initially occurs in the region of the higher transition resistance between the tube 2, the hard solder 5 and the strand 4, which causes a connection of the outer layer of the strand 4 with the tube 2 by the melting of the hard solder, thereby reducing the transition resistance in this region. With further energization, usually with process parameters different from hard soldering, the Joule heating now occurs in the region between the individual wires of the strand, which region offers a greater transition resistance, so that the individual wires are connected to each other by diffusion or by a melting process, which in turn reduces the transition resistance between the individual wires. The heat input from a heating or self-heating of the electrodes can provide support here.

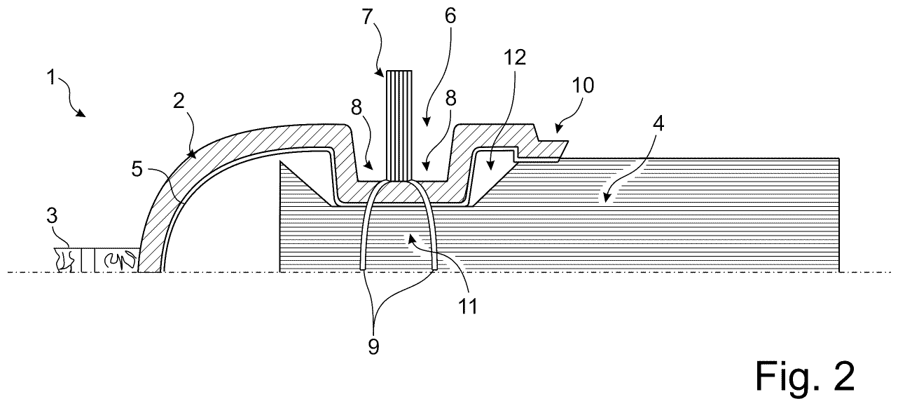

FIG. 2 shows that in the course of creating the plastic deformation 6 on the terminal side, a further deformation was formed as a sealing sleeve 10 on the conductor side. The sealing sleeve 10 is less strongly stamped into the tube 2 than the plastic deformation 6 on the terminal side. However, the sealing sleeve 10 ensures that the melt produced in the melt zone 11 can only reach a melt reserve 12 and cannot escape to the outside.

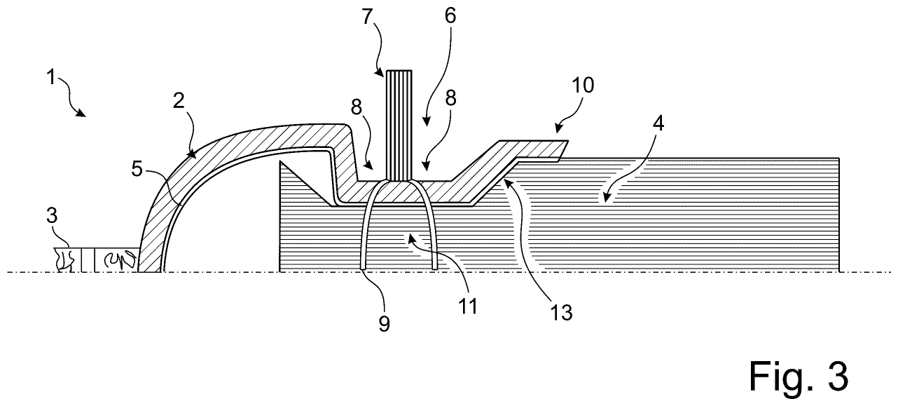

In FIG. 3, in addition to the plastic deformation 6 on the terminal side, a deformation on the conductor side has also been arranged for the forming of a sealing sleeve 10. However, the melt reserve 12 is only very small or is not present at all. While any melt that may occur can enter between the individual wires of the strand 4 in the region of an expansion zone 13, it cannot escape through the sealing sleeve 10.

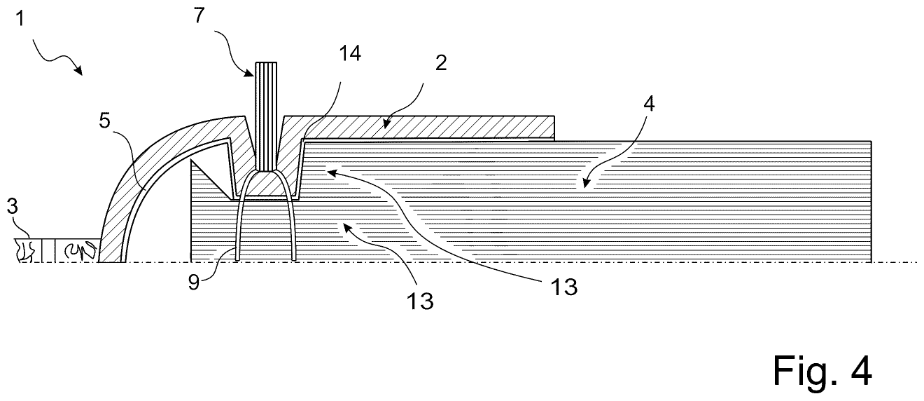

FIG. 4 shows an electrical terminal 1 which has been deformed by means of the electrode 7 and in which the hard soldering process has subsequently occurred in the first stage and the diffusion or welding process in the second stage. Since the electrode 7 is also partially in contact with the side walls of the plastic deformation 6 on the terminal side, larger regions of the melted hard solder 14 can be seen here.

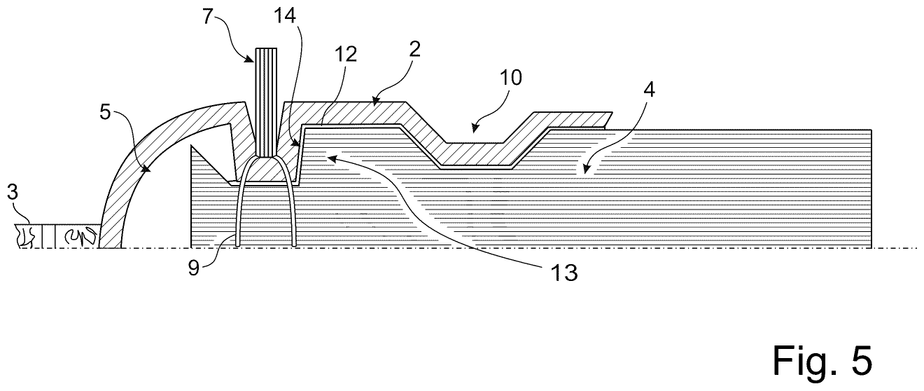

FIG. 5 shows a modification of FIG. 4. A sealing sleeve 10 was also stamped here, which in turn shows a melt reserve 12 between the sealing sleeve and the plastic deformation 6 on the terminal side.

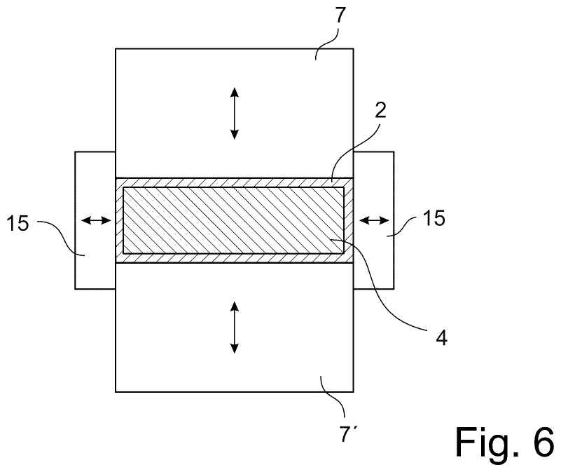

FIG. 6 shows the electrodes 7 and 7′. In particular, it shows that these two electrodes 7 can be moved towards each other. As a result, the outer wires of the strand 4 are expanded approximately equally during the plastic deformation process, which expands the strand less compared to a pair of electrodes 7, 7′ in which only one electrode 7 is moved.

Furthermore, it can be seen that the tube 2 with the strand 4 inside is severely squeezed, so that the tube 2 assumes an essentially rectangular shape. To prevent the tube 2 from escaping at the sides between the electrodes 7, 7′, a lateral boundary 15 is provided, which additionally ensures that the tube 2 and the strand 4 retain their plastic deformation without any possible widening, so that no gas can reach the strand 4 during the subsequent connection steps.

It is thus essential that, in a first step, after a compacting process, the tube is soldered to the surface wires of the strand and that, in a second step, the inner regions of the strand are firmly connected to each other by diffusion and/or melting.

It is known that an Al—Cu intermetallic phase (IMP), which is highly resistive and brittle, arises in an Al—Cu melt. This is a known problem in the field. The high resistance leads to partial overheating in the crimp and the brittleness to cracks in the connection point in the event of external forces or temperature changes, combined with strongly fluctuating transition resistances and partial overheating. Contact corrosion can also form in these cracks between these electrochemically very different materials. There is also the suggestion of applying an oxidation protection, usually a tin coating, to the aluminum wires and/or the copper tube and soldering them. In this case, CuSn IMPs are formed, which are also highly resistive and brittle. Field failures can result here as well.

To avoid these field risks, a diffusion barrier is proposed, which additionally forms a eutectic with the aluminum. The temperature of the eutectic must be lower than the melting temperature of the two connection partners, Al and Cu. The property of the diffusion barrier prevents the formation of critical Al—Cu IMP. Nickel and its alloys, in addition to silver, are a particularly suitable coating material for this purpose. A temperature-related loss of strength, as with tin or zinc solder, does not occur with silver or nickel solder. Nickel is successfully used as a diffusion barrier in wire bonding (avoidance of Kirkendahl voids), in soft soldering (avoidance of epsilon-eta layers) and in spot welding (avoidance of tin whiskers). In this way, during the first step, a hard solder connection is created between the coating applied to the copper and the pressed-on Al wires which have been pressed on, freed from the oxide skin and have not yet been melted. The coating may also be oxidized, but its oxide skin is also broken by the earlier deformation process.

After the formation of the hard solder connection between nickel and aluminum, the Al composite heats up further in the second step until the Al wires between the electrode zones transition into a locally limited melt or diffusion bond. This is not resistance welding of the aluminum stranded wires, but a complete or only partial melting or initial diffusion at the adjoining contact surfaces. The heating process required for this must be regulated/controlled in such a way that the hard solder connection take place prior to the melting. This sequence is achieved by dividing the connection process into at least two different steps, usually with different parameter settings. In the first step, starting with a preheating stage (stepped and/or ramped current increase), the well-metered energy required for hard soldering is introduced. In the second step, the energy required for melting or initial diffusion of the Al wires is added. Different parameter settings are generally required here. The main parameters which need to be balanced are the current, the duration and the pressing force. If a plastic deformation with additional heating of the shaping tools is used, the energy used can be included in the total energy of the hard soldering-diffusion-melting process. Depending on the mechanical dimensions, the electrode size, the electrode material, the formation of the deformation zone, etc., additional steps with still different settings may be required.

Hard solders can be inserted as shaped part, but are preferably applied to the tube and possibly to the strand using galvanic or physical means (e.g., spraying, sputtering). Additional oxidation protection for the base material is attained with the coating.

The current flow during the connecting takes place via the opposing electrodes adjoining the top and bottom sides. The conductivity of the electrodes can be selected such that the electrodes generate additional heat for the connection process. The aim is that the necessary heating is generated by Joule heat in the material to be connected, but the additional electrode heat can accelerate the heating process and reduce heat loss via the electrodes. The heat required for the connection is thus not primarily supplied by the self-heating of the electrodes, but is generated by the current flow in the composite system of copper tube-coating-aluminum strand. As a poorly conductive material, nickel would be advantageous here as well since the Joule heat is then generated directly in the contact zone in addition to the aluminum portion.

A slight additional heating by the electrode material can be helpful since this reduces the heat loss via the electrodes.

The effect of the electrode current can also be influenced by the contact surface and the contour on the contact side. Here, the electrodes can be formed plane-parallel, partially or completely convex, or concave.

### REFERENCE SYMBOL LIST

1 Electrical terminal
2 Tube
3 Terminal element
4 Strand
5 Hard solder
6 Terminal-side plastic deformation
7 Electrode
8 Termination zones
9 Current flow lines
10 Sealing sleeve
11 Melt zone
12 Melt reserve
13 Expansion zone
14 Melted hard solder
15 Lateral boundaries

1.-8. (canceled)

9. A method for connecting an electrical conductor formed as an aluminum or aluminum alloy strand (4), to a copper or copper alloy electrical terminal (1), the copper or copper alloy electrical terminal (1) comprising a terminal element (3) and a tube (2) for accommodating an end of the electrical conductor, the method comprising:
a) coating an inner surface of the tube (2) with a hard solder (5) or providing the tube (2) coated on the inner surface with the hard solder (5);
b) inserting the end of the electrical conductor into the tube (2) and thereafter plastically deforming the tube (2) in a region of an end of the tube (2) on a terminal element side, wherein individual wires of the aluminum or aluminum alloy strand (4) are deformed by overstamping in such a way that their non-conductive layers are broken up and the individual wires are pressed together in a gap-free manner;
c) applying a predeterminable pressing force and a predeterminable current for a predeterminable time via electrodes (7, 7′), depending on a geometry and material properties of the tube (2) and the aluminum or aluminum alloy strand (4), for Joule heating the aluminum or aluminum alloy strand (4), wherein the Joule heating melts the hard solder (5) and creates a hard solder connection between the inner surface of the tube (2) and outer regions of the aluminum or aluminum alloy strand (4) in contact therewith;
d) applying a further predeterminable pressing force and a further predeterminable current for a further predeterminable time, also depending on the geometry and the material properties of the tube (2) and the aluminum or aluminum alloy strand (4) for softening the aluminum or aluminum alloy strand (4) such that a diffusion of the aluminum or aluminum alloy strand (4) and/or an at least partial melting of the aluminum or aluminum alloy strand (4) occurs.

10. The method according to claim 9, wherein
the method steps b) and c) are carried out simultaneously or immediately one after the other.

11. The method according to claim 9, further comprising
e) after inserting the end of the electrical conductor into the tube (2), plastically deforming the conductor in the region of its end on a conductor side in such a way that the tube (2) fits against the electrical conductor in the form of a sealing sleeve (10).

12. The method according to claim 11, further comprising
f) forming a melt reserve (12) between the deformation on the terminal element side and the deformation on the conductor end side.

13. The method according to claim 12,
wherein method steps e) and f) are carried out simultaneously with method step b) or at the latest before a start of method step d).

14. The method according to claim 9,
wherein during method step b) and/or c) and/or d) pressing tools or the electrodes (7, 7′) are heated or consist of a material which heats up when current flows through it.

15. The method according claim 9,
wherein tools or the electrodes (7, 7′) of pressing tool pairs and/or electrode pairs are moved simultaneously.

16. The method according to claim 9,
wherein in method step c) the electrodes (7, 7′) having an active surface smaller than the active surface of deformation tools in method step b) are used and
wherein non-conductive lateral boundaries (15) of the tube (2) provide a desired shape in the deformation and energization region.
